(19) United States
(12) Patent Application Publication
(10) Pub. No.: US 2014/0237723 A1
(43) Pub. Date: Aug. 28, 2014

(54) ADJUSTABLE BED

(71) Applicant: INVACARE CORPORATION, Elyria, OH (US)

(72) Inventors: Kevin Wysocki, Grafton, OH (US); Jason Biter, Medina, OH (US)

(73) Assignee: INVACARE CORPORATION, Elyria, OH (US)

(21) Appl. No.: 13/779,866

(22) Filed: Feb. 28, 2013

(51) Int. Cl. A61G 7/015

(52) U.S. Cl. CPC A61G 7/015
USPC 5/613

(57) ABSTRACT

A bed is disclosed in the present application. In certain embodiments, the bed comprises a frame, a mattress support coupled to the frame and moveable between a substantially flat position and an elevated position, and an actuator coupled to the frame and the mattress support for moving the mattress support between the substantially flat position and the elevated position. The mattress support comprises a first section and a second section. The first section is pivotally connected to the frame and to the second section. The second section is pivotally connected to at least one connecting link. The connecting link is pivotally connected to the frame.

### BACKGROUND

Patients residing in long-term care facilities such as nursing homes and rehabilitation facilities usually require beds that include moveable head end and foot end sections of the sleep surface. The head end section has an adjustable portion that can be raised up when the bed is assembled, to raise the patient's head. The foot end section has an adjustable portion that can be raised up when the bed is assembled, to raise the patient's knees. The sleep surface and related components are attached to a frame which provides a rigid supporting structure. Also attached to the frame are the components for elevating or tilting the bed frame relative to the support surface. These beds typically utilize multiple manual crank devices or electric actuators to provide separate elevating movement of the head end and foot end sections of the sleep surface and also to raise, lower or tilt the entire frame and sleep surface relative to the support surface.

### SUMMARY

According to one embodiment, the bed includes a frame, a mattress support coupled to the frame and moveable between a substantially flat position and an elevated position, and an actuator coupled to the frame and to the mattress support for moving the mattress support between the substantially flat position and the elevated position. The frame comprises a pair of spaced apart rails and at least one cross member extending between the pair of spaced apart rails. The mattress support comprises a first section and a second section. The first section is pivotally connected to the frame and to the second section. The second section is pivotally connected to at least one connecting link and the connecting link is pivotally connected to the cross member extending between the rails of the frame. In certain embodiments, the connecting link maintains a continuous gap between the frame rails and the mattress support between a first pivotal connection and a distal end of the second section. Further, in certain embodiments, the bed may not have any moving parts proximate the frame rails and between the first pivotal connection and the distal end of the second section.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to provide examples of the principles of this invention.

FIG. 1A is a top perspective view of an adjustable bed according to an embodiment of the present application.

FIG. 1B is a bottom perspective view of the adjustable bed shown in FIG. 1A.

FIG. 1C is a bottom view of the adjustable bed shown in FIG. 1A.

FIG. 2A is a side view of the adjustable bed shown in FIG. 1A, wherein mattress supports of the bed are in a substantially flat or horizontal position.

FIG. 2B is a side view of the adjustable bed shown in FIG. 1A, wherein the mattress supports of the bed are in a partially elevated position.

FIG. 2C is a side view of the adjustable bed shown in FIG. 1A, wherein the mattress supports of the bed are in an elevated position.

FIG. 3A is a partial, cross sectional side view of the adjustable bed shown in FIG. 1A, wherein a foot end mattress support of the bed is in a substantially flat or horizontal position.

FIG. 3B is a partial, cross sectional side view of the adjustable bed shown in FIG. 1A, wherein the foot end mattress support of the bed is in a partially elevated position.

FIG. 3C is a partial, cross sectional side view of the adjustable bed shown in FIG. 1A, wherein the foot end mattress support of the bed is in an elevated position.

FIG. 4A is a side view of a mattress support according to an embodiment of the present application, wherein the mattress support is in a substantially flat or horizontal position.

FIG. 4B is a side view of the mattress support shown in FIG. 4A, wherein the mattress support is in a partially elevated position.

FIG. 4C is a side view of the mattress support shown in FIG. 4A, wherein the mattress support is in an elevated position.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meaning.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements.

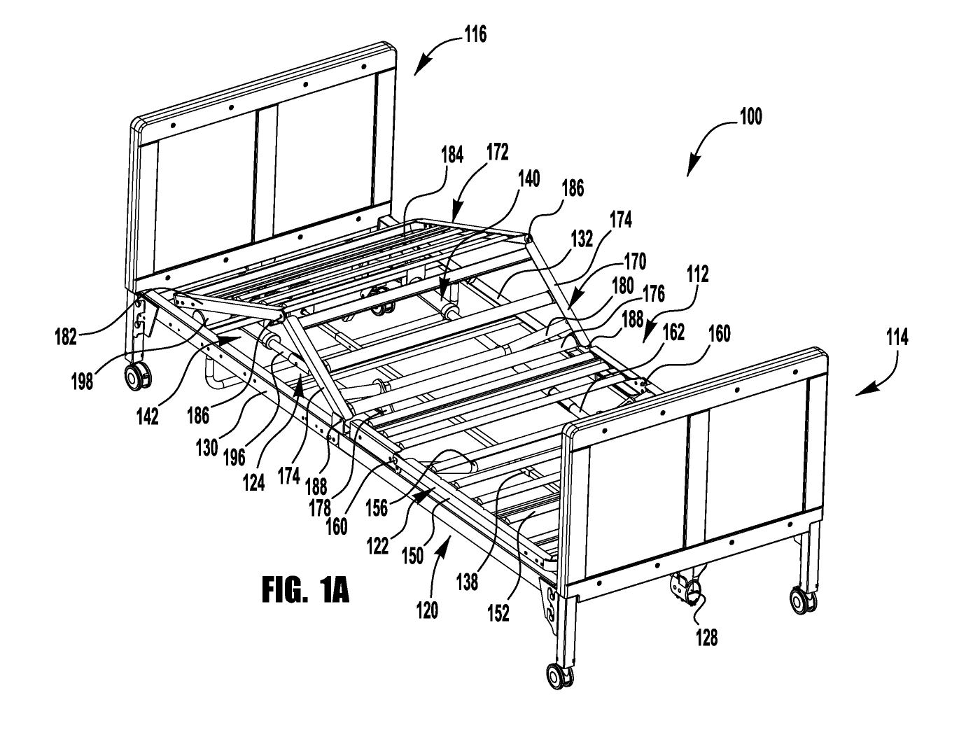

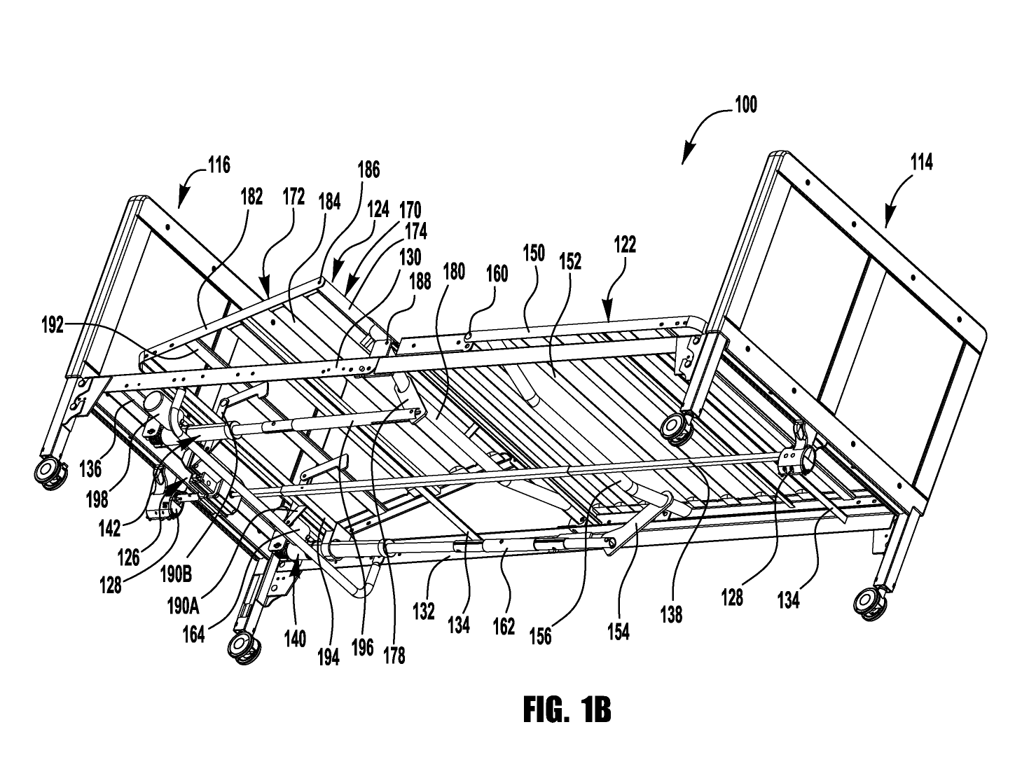

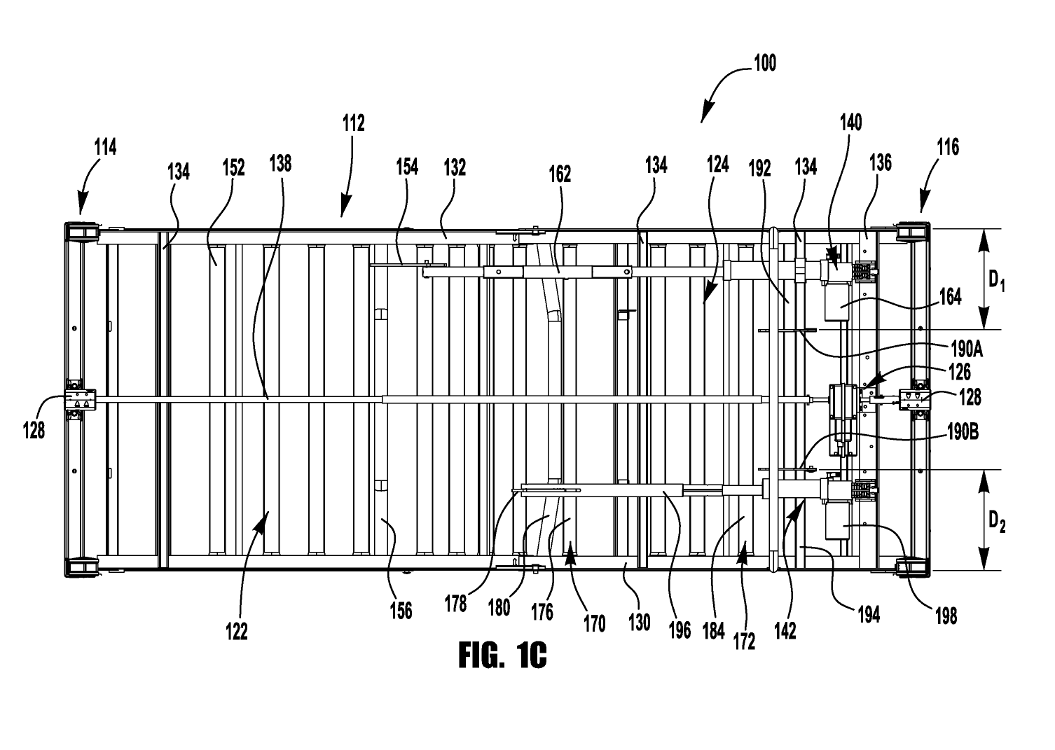

FIGS. 1A-1C illustrate an exemplary embodiment of an adjustable bed 100. The bed 100 can take a wide variety of different forms. The illustrated bed 100 includes a bed platform 112, a first or head bed end 114, and a second or foot bed end 116. The bed ends 114 and 116 support the bed platform 112 above a support surface, such as a floor. The bed ends 114 and 116 are optionally configured to raise and lower the bed platform 112 with respect to the support surface and may be identical.

The bed platform 112 can take a wide variety of different forms. As illustrated in FIGS. 1A-1C, the bed platform 112 comprises a support frame 120, a first or head end mattress support 122 movably coupled to the support frame, and a second or foot end mattress support 124 movably coupled to the support frame.

In certain embodiments, the bed platform 112 may include first and second platform sections that are assembled together, such as a head end platform section and a foot end platform section. The head end platform section and the foot end platform section can take a wide variety of different forms. For example, the head end platform section may include a head end support frame, a head end mattress support, and a head end actuator. Further, the foot end platform section may include a foot end support frame, a foot end mattress support, and a foot end actuator.

The support frame 120 of the bed platform 112 can take a wide variety of different forms. As illustrated in FIGS. 1A-1C, the support frame 120 includes a pair of spaced apart rails 130 and 132 and a plurality of cross members 134 extending between the pair of spaced apart rails. The spaced apart rails 130 and 132 are connected together by the cross members 134 and the bed ends 114 and 116. In certain embodiments, the support frame 120 comprises two or more frame sections assembled together, each frame section comprising a pair of spaced apart rails and at least one cross member extending between the pair of spaced apart rails.

As illustrated in FIGS. 1A-1C, the bed platform 112 comprises a head end actuator 140 for moving the head end mattress support 122 relative to the support frame 120 and a foot end actuator 142 for moving the foot end mattress support 124 relative to the support frame. As illustrated in FIGS. 1B and 1C, the head end actuator 140 and the foot end actuator 142 are coupled to an actuator support member 136 extending between the pair of spaced apart rails 130 and 132 of the support frame 120. The actuators 140 and 142 may be directly coupled to the actuator support member 136 of the support frame 120 or indirectly coupled to the support member by one or more intermediate members. Examples of suitable coupling arrangements include, but are not limited to, fasteners, such as pins, nuts, bolts, etc., quick connect arrangements, and telescoping arrangements.

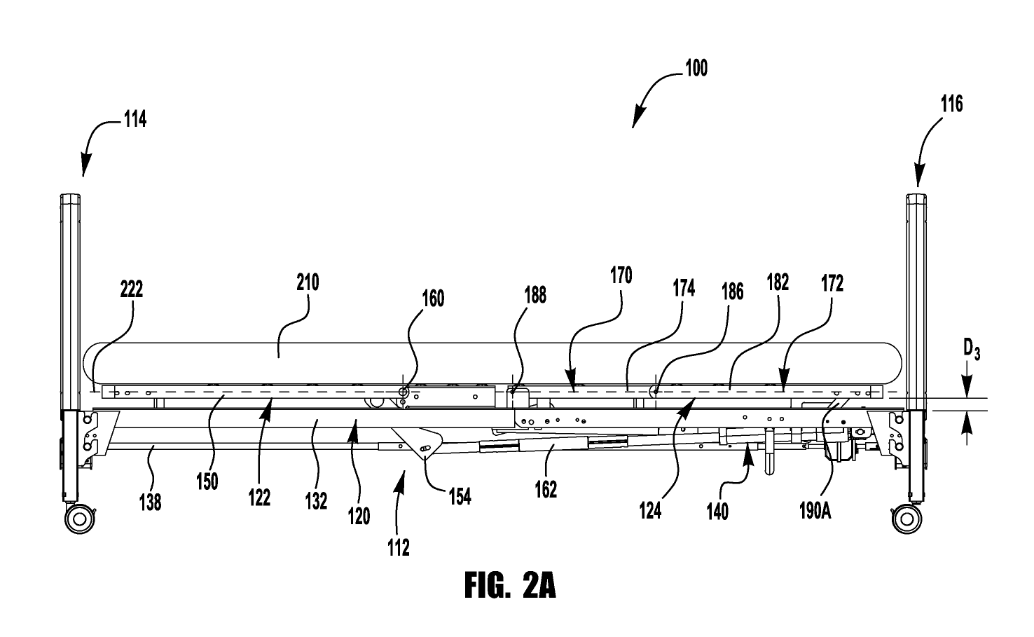

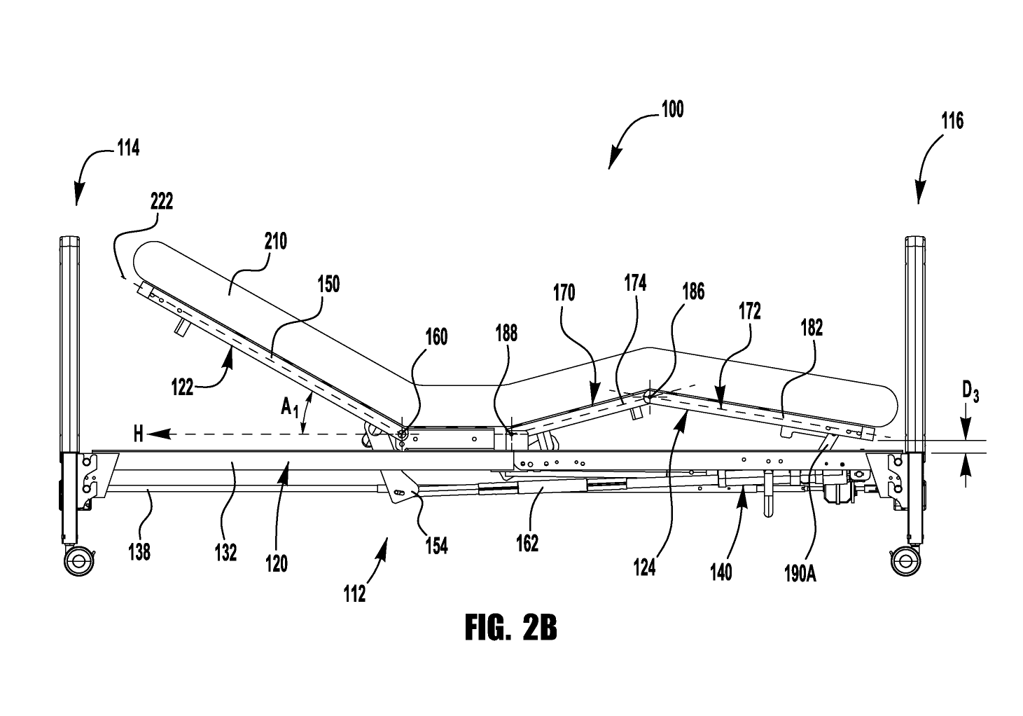

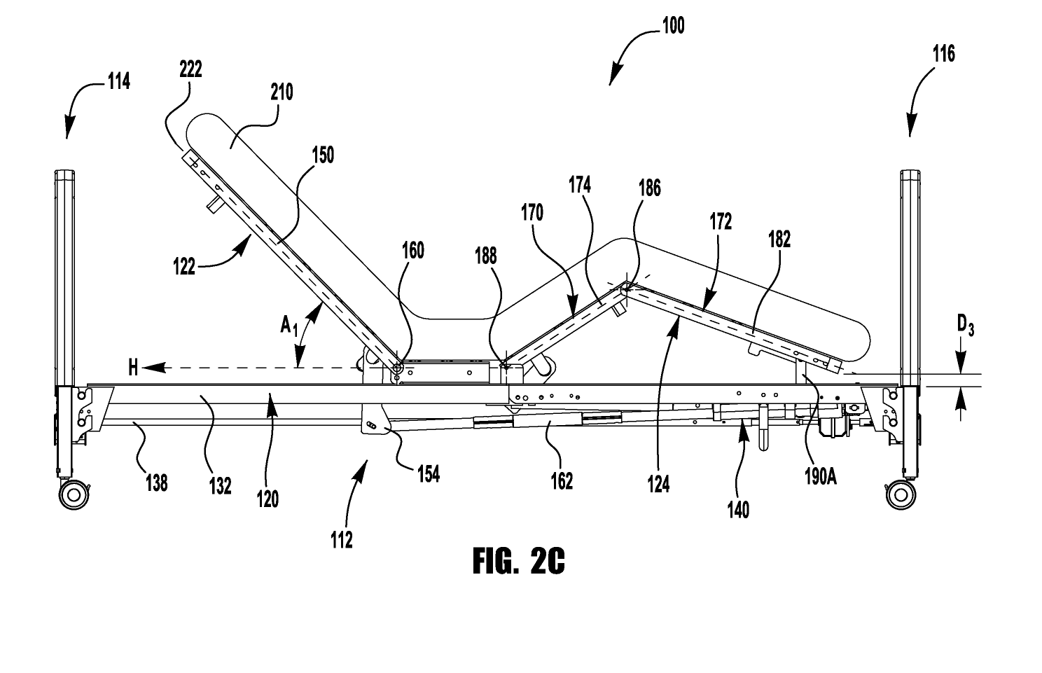

FIGS. 2A-2C illustrate the movement of the mattress supports 122 and 124 and the mattress 210 relative to the support frame 120 of the bed 100. As shown, the mattress supports 122 and 124 and the mattress 210 are moved relative to the support frame 120 between a neutral position (which may, but need not, be substantially flat or horizontal as shown in FIG. 2A), a partially elevated position (see FIG. 2B), and an elevated position (see FIG. 2C).

The head end mattress support 122 can take a wide variety of different forms. Any structure capable of supporting and positioning the head end of the mattress 210 can be used as the head end mattress support 122. The head end mattress support 122 can be coupled to the support frame 120 in a wide variety of different ways. Any coupling that allows the head end mattress support 122 to be moved between the neutral position and the elevated position can be used.

As illustrated in FIGS. 1A-1C, the head end mattress support 122 comprises a u-shaped outer frame 150 and mattress support slats 152 extending across the frame. A head end actuator mounting bracket 154 is mounted to a cross member 156 of the frame 150. End portions of the frame 150 are pivotally connected to the support frame 120 at pivot connections 160. As such, the head end mattress support 122 can pivot between the neutral position, the partially elevated position, and the elevated position. As illustrated in FIGS. 2A-2C, the angle A₁ between the longitudinal axis 222 of the head end mattress support 122 and horizontal H generally ranges from about 0 degrees in the substantially flat position to about 70 degrees when the head end mattress support is in the elevated position.

The head end actuator 140 can take a wide variety of different forms. Any arrangement capable of moving the head end mattress support 122 between the neutral position, the partially elevated position, and the elevated position can be used. Exemplary head end actuators 122 include, but are not limited to, electric actuators, hydraulic actuators, pneumatic actuators, pulley and cable arrangements, gear arrangements, nut and shaft arrangements, combinations and sub-combinations of any of these arrangements, and the like. As illustrated in FIGS. 1A-2C, the head end actuator 140 includes an extendable/retractable shaft 162. The force required to extend and retract the shaft 162 can be provided in a variety of different ways. For example, the shaft 162 may be extended and retracted with a motor, hydraulic fluid, air, magnetic force, and/or a spring, or any combination thereof. In the illustrated embodiment, the shaft 162 is extended and retracted by operation of an electric motor 164.

As illustrated in FIGS. 1A-2C, the head end actuator 140 is coupled to the actuator support member 136 of the support frame 120 and to the head end mattress support 122 for moving the head end mattress support between the neutral position, the partially elevated position, and the elevated position. The head end actuator 140 may be coupled to the actuator support member 136 and to the head end mattress support 122 in a wide variety of different ways. As shown, the head end actuator 140 is coupled to the actuator support member 136 and to the actuator mounting bracket 154. The head end actuator 140 may be coupled to the actuator support member 136 and to the actuator mounting bracket 154 in a wide variety of different ways. Referring to FIGS. 1B-2C, in the illustrated embodiment, the head end actuator 140 is pivotally connected to a bracket extending from the actuator support member 136 at a pivot axis and is pivotally connected to the actuator mounting bracket 154 at a pivot axis. As illustrated in FIGS. 2A-2C, extension of the head end actuator 140 moves the head end mattress support 122 toward the elevated position and retraction of the head end actuator moves the head end mattress support toward the neutral position. However, other actuator arrangements may move the head end mattress support 122 in other manners.

The foot end mattress support 124 can take a wide variety of different forms. Any structure capable of supporting and positioning a foot end of the mattress 210 can be used as the foot end mattress support 124. The foot end mattress support 124 can be coupled to the support frame 120 in a wide variety of different ways. Any coupling that allows the foot end mattress support 124 to be moved between the neutral position, the partially elevated position, and the elevated position can be used.

As illustrated in FIGS. 1A-1C, the foot end mattress support 124 includes a first frame section 170 and a second frame section 172 that are pivotally connected together. As shown, the first frame section 170 includes spaced apart parallel frame members 174 and mattress support slats 176 extending between the frame members. A foot end actuator mounting bracket 178 is mounted to a cross member 180 extending between the frame members 174 of the first frame section 170. The second frame section 172 includes a u-shaped outer frame 182 and mattress support slats 184 extending across the frame.

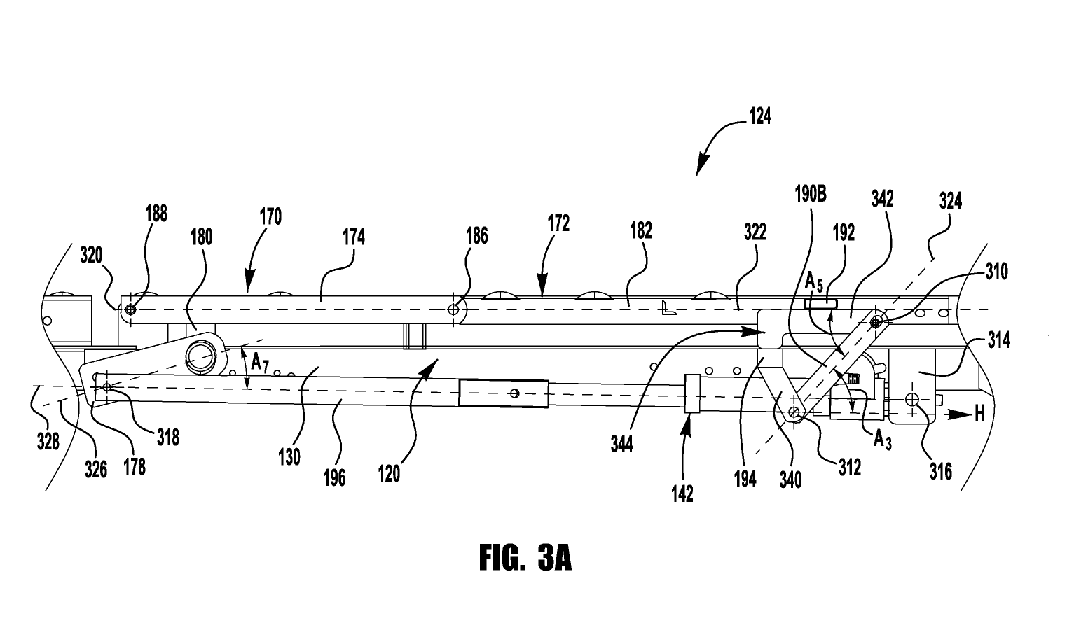

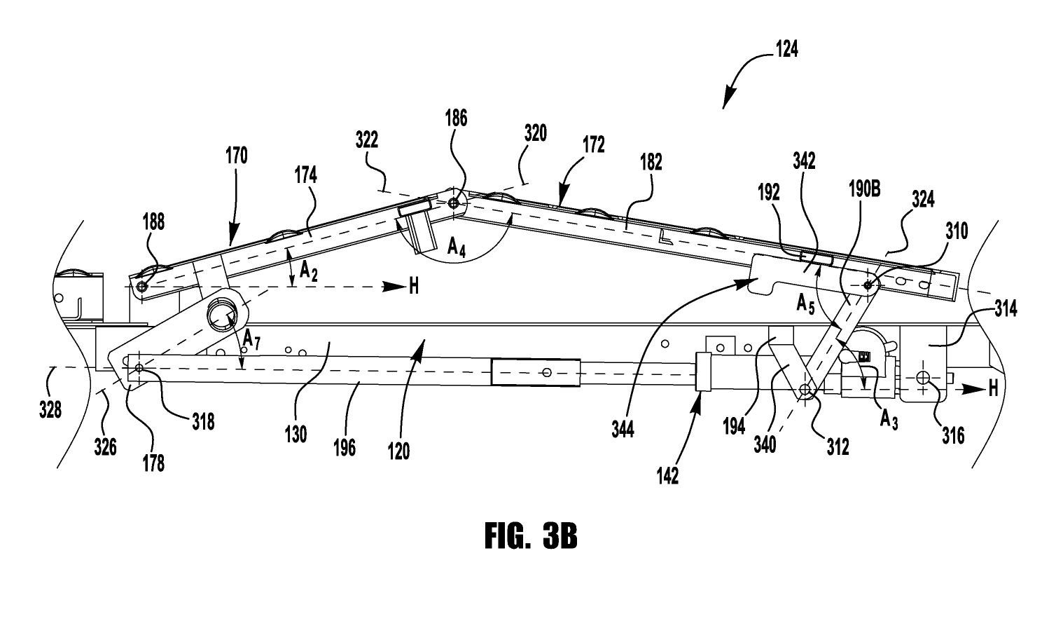

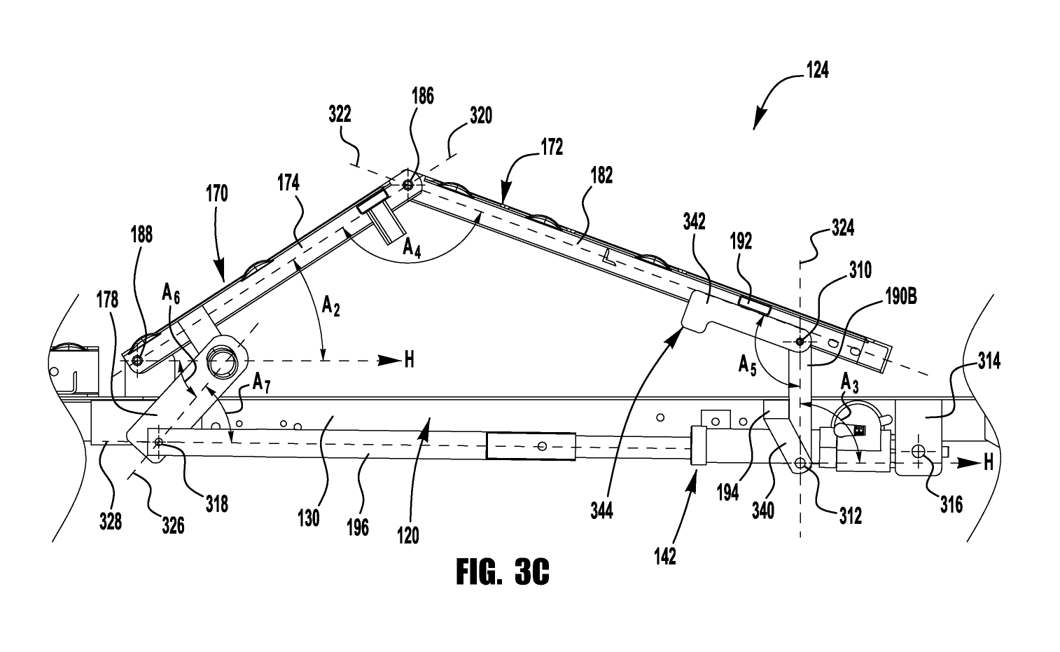

As illustrated in FIGS. 1A-1C, end portions of the first frame section 170 are pivotally connected to end portions of the second frame section 172 at pivot connections 186. The first and second frame sections 170 and 172 are pivotally coupled together at or near the expected position of an occupant's knee area to follow the natural contours of a person. Further, end portions of the first frame section 170 are pivotally connected to the support frame 120 at pivot connections 188. As illustrated in FIGS. 1B and 1C, connecting links 190A and 190B couple the second frame section 172 to the support frame 120. The connecting links 190A and 190B are pivotally connected to a cross member 192 of the second frame section 172 at pivot connections 310 (see FIGS. 3A-3C) and a cross member 194 of the support frame 120 at pivot connections 312 (see FIGS. 3A-3C). As such, the first and second frame sections 170 and 172 of the foot end mattress support 124 can move between the neutral position, the partially elevated position, and the elevated position.

As illustrated in FIGS. 1B-1C and 3A-3C, the first connecting link 190A and the second connecting link 190B of the bed platform 112 couple the second frame section 172 to the cross member 194 of the support frame 120. Each connecting link 190A and 190B is pivotally connected to the second frame section 172 and to the cross member 194 extending between the rails 130 and 132 of the support frame 120. In certain embodiments, however, more or less connecting links may be used to couple the second frame section 172 to the cross member 194 of the support frame 120, such as, for example, one connecting link, three connecting links, four connecting links, and so on.

The connecting link may take a wide variety of different forms. For example, the connecting link may be a variety of different sizes and shapes, such as, for example, tubular, flat, circular, triangular, square, rectangular, etc. The cross sectional shape of the connecting link may also vary along the length of the connecting link. For example, the connecting link may be thinner towards the ends than the middle and/or the ends of the connecting link may be flat and the middle tubular. Further, the connecting link may be pivotally connected to the frame or the mattress support in a wide variety of different ways. For example, the pivotal connection may include a clevis, bracket, flange, ball joint, socket, bearing, pin, one or more slots, elastomeric member, or any other mechanism that permits the connecting link to pivot or rotate relative to the frame and/or mattress support.

The connecting links may also be spaced in a variety of ways. For example, in one embodiment, the bed includes a single connecting link that is disposed substantially along the centerline of the bed. In another embodiment, the bed includes two connecting links, each connecting link disposed substantially the same distance from the centerline of the bed. In yet another embodiment, the bed includes three or more connecting links spaced approximately equidistant across the width of the bed. The connecting links may also be longitudinally offset from each other in certain embodiments.

As illustrated in FIG. 1C, the first connecting link 190A is located a distance D₁ from the outside edge of the support frame rail 132 and the second connecting link 1908 is located a distance D₂ from the outside edge of the support frame rail 130. The distances D₁ and D₂ are generally between about 200 mm and about 350 mm. In certain embodiments, the connecting links 190A and 190B of the bed platform 112 are both located at least 200 mm from the outside edges of both support frame rails 130 and 132. As such, the connecting links 190A and 190B are out of reach, such as, for example, out of reach of a person that may be grasping the sides of the second frame section 172 or the support frame rails 130 and 132 as the mattress supports 122 and 124 are moved relative to the support frame 120 between the neutral position and the elevated position.

As illustrated in FIGS. 2A-2C, the connecting links 190A and 190B are configured to provide vertical separation D₃ between the bottom of the second frame section 172 and the top of the support frame rails 130 and 132 when the foot end mattress support 124 is moving between the substantially flat position and the elevated position. The amount of vertical separation D₃ is generally between about 25 mm and about 35 mm as the foot end mattress support 124 moves between the substantially flat position and the elevated position. In certain embodiments, the connecting links 190A and 190B are configured to provide at least 25 mm of vertical separation D₃ when the foot end mattress support 124 is moving between the substantially flat position and the elevated position. As such, the connecting links 190A and 190B provide space between the bottom of the second frame section 172 and the top of the support rails 130 and 132 for a user's hand that may be grasping the sides of the second frame section or the support frame rail.

FIGS. 2A-2C and 3A-3C illustrate a method of adjusting the mattress supports 122 and 124 and the mattress 210 relative to the support frame 120 of the bed 100. As shown, the mattress supports 122 and 124 and the mattress 210 are moved relative to the support frame 120 between the neutral position, the partially elevated position, and the elevated position. The head and foot end actuators 140 and 142 are used to move the mattress supports 122 and 124 relative to the support frame 120. The foot end actuator 142 is also used to pivot the connecting links 190A and 190B relative to the support frame 120. As shown in FIGS. 1A-1B and 2A-2C, the connecting links 190A and 190B maintain a continuous gap between the support frame rails 130 and 132 and the mattress support 124 between the pivot connection 188 and a distal end of the second frame section 172 as the mattress support moves between the substantially flat position and the elevated position. As such, there are no moving parts proximate the support frame rails 130 and 132 and between the pivot connection 188 and the distal end of the second frame section 172.

The foot end actuator 142 can take a wide variety of different forms. Any arrangement capable of moving the foot end mattress support 124 between the neutral position, the partially elevated position, and the elevated position can be used. Examples of foot end actuators 142 include, but are not limited to, electric actuators, hydraulic actuators, pneumatic actuators, pulley and cable arrangements, gear arrangements, nut and shaft arrangements, combinations and sub-combinations of any of these arrangements, and the like. As illustrated in FIGS. 1A-1C, the foot end actuator 142 includes an extendable/retractable shaft 196. The force required to extend and retract the shaft 196 can be provided in a variety of different ways. For example, the shaft 196 may be extended and retracted with a motor, hydraulic fluid, air, magnetic force, and/or a spring, and any combination thereof. As shown, the shaft 196 is extended and retracted by operation of a motor 198.

As illustrated in FIGS. 1A-1C, the foot end actuator 142 is coupled to the actuator support member 136 of the support frame 120 and to the foot end mattress support 124 for moving the foot end mattress support between the neutral position, the partially elevated position, and the elevated position. The foot end actuator 142 may be coupled to the actuator support member 136 and to the foot end mattress support 124 in a wide variety of different ways. As shown, the foot end actuator 142 is coupled to the actuator support member 136 and to the actuator mounting bracket 178. The foot end actuator 142 may be coupled to the actuator support member 136 and to the actuator mounting bracket 178 in a wide variety of different ways. Referring to FIGS. 1B and 3A-3C, in the illustrated embodiment, the foot end actuator 142 is pivotally connected to a bracket 314 extending from the actuator support member 136 at a pivot axis 316 and is pivotally connected to the actuator mounting bracket 178 at a pivot axis 318. As illustrated in FIGS. 3A-3C, extension of the foot end actuator 142 moves the foot end mattress support 124 toward the neutral position shown in FIG. 3A and retraction of the foot end actuator moves the foot end mattress support toward the elevated position shown in FIG. 3C. However, other actuator arrangements may move the foot end mattress support 124 in other manners.

The bed ends 114 and 116 may be configured in a variety of different ways to raise and lower the bed platform 112 relative to the support surface. For example, as illustrated in FIGS. 1A-1C, a motor/gearbox assembly 126 coupled to the actuator support member 136 of the support frame 120 is used to raise and lower the bed platform 112 relative to the support surface. As shown, a shaft 138 connects the motor/gearbox assembly 126 to gearboxes 128 on each bed end 114 and 116. The gearboxes 128 are operatively connected to the caster assemblies of the bed ends 114 and 116 such that rotation of the shaft 138 moves the caster assemblies relative to the legs that support the bed platform 112. As such, the bed platform 112 is raised and lowered relative to the support surface by the motor/gearbox assembly 126. In certain embodiments, the bed ends 114 and 116 are identical such that they are interchangeable.

FIGS. 3A-3C are partial, cross sectional views of the second or foot end mattress support 124 that illustrate the movement of the foot end mattress support relative to the support frame 120 of the bed platform 112. As shown, the foot end mattress support 124 is coupled to the support frame 120 and moveable between a substantially flat or horizontal position shown in FIG. 3A, a partially elevated position shown in FIG. 3B, and an elevated position shown in FIG. 3C. The actuator 142 is coupled to the support frame 120 and to the foot end mattress support 124 for moving the mattress support between the substantially flat position and the elevated position.

The first frame section 170 of the foot end mattress support 124 is pivotally connected to the support frame 120 and to the second frame section 172. The second frame section 172 is pivotally connected to at least one connecting link 190B. The connecting link 190B is pivotally connected to the cross member 194 extending between the rails 130 and 132 of the support frame 120. As illustrated in FIGS. 1B and 1C and described above, the connecting link 109B may be spaced away or inward from an outside edge of the rail 130. Further, because FIGS. 3A-3C are cross sectional views, only connecting link 190B is shown. However, the description herein related to the connecting link 190B may also be applied to the connecting link 190A.

As illustrated in FIGS. 3A-3C, the first frame section 170 is connected to the support frame 120 at the first pivotal connection 188 and the second frame section 172 at the second pivotal connection 186. The second frame section 172 is also connected to the connecting link 190B at the third pivotal connection 310 and the connecting link is connected to the support frame 120 at the fourth pivotal connection 312.

As illustrated in FIGS. 3A-3C, the angle A₂ between the longitudinal axis 320 of the first frame section 170 and horizontal H generally ranges from about 0 degrees when the foot end mattress support 124 is in the substantially flat position to about 33 degrees when the foot end mattress support is in the elevated position. The angle A₃ between the longitudinal axis 324 of the connecting link 190B and horizontal H generally ranges from about 48 degrees when the foot end mattress support 124 is in the substantially flat position to about 90 degrees when the foot end mattress support is in the elevated position. The angle A₄ between the longitudinal axis 320 of the first frame section 170 and the longitudinal axis 322 of the second frame section 172 generally ranges from about 180 degrees when the foot end mattress support 124 is in the substantially flat position to about 127 degrees when the foot end mattress support is in the elevated position. The angle A₅ between the longitudinal axis 322 of the second frame section 172 and the longitudinal axis 324 of the connecting link 190B generally ranges from about 48 degrees when the foot end mattress support 124 is in the substantially flat position to about 111 degrees when the foot end mattress support is in the elevated position.

As illustrated in FIGS. 3A-3C, the length of the first frame section 170 between the first pivotal connection 188 and the second pivotal connection 186 is generally between about 250 mm and about 375 mm. The length of the second frame section 172 between the second pivotal connection 186 and the third pivotal connection 310 is generally between about 450 mm and about 650 mm. The length of the connecting link 190B between the third pivotal connection 310 and the fourth pivotal connection 312 is generally between about 100 mm and about 200 mm. In certain embodiments, the length of the first frame section 170 between the first and second pivotal connections 188 and 186 is about 370 mm; the length of the second frame section 172 between the second and third pivotal connections 186 and 310 is about 484 mm; and the length of the connecting link 190B between the third and fourth pivotal connections 310 and 312 is about 139 mm.

As illustrated in FIGS. 3A-3C, the vertical distance between the first and fourth pivotal connections 188 and 312 is generally between about 75 mm and about 150 mm and the horizontal distance between the first and fourth pivotal connections is generally between about 700 mm and about 800 mm. In certain embodiments, the vertical distance between the first and fourth pivotal connections 188 and 312 is about 118 mm and the horizontal distance between the first and fourth pivotal connections is about 760 mm. Further, the vertical distance between the second pivotal connection 186 and the top of the support frame rail 130 is generally between about 200 mm and about 275 mm when the foot end mattress support 124 is in the elevated position. In certain embodiments, the vertical distance between the second pivotal connection 186 and the top of the support frame rail 130 is about 245 mm when the foot end mattress support 124 is in the elevated position. The horizontal distance between third pivotal connection 310 and the fourth pivotal connection 312 generally decreases from about 94 mm when the foot end mattress support 124 is in the substantially flat position to about 0 mm when the mattress support is in the elevated position.

As illustrated in FIGS. 3A-3C, the connecting link 190B is connected to a first bracket 340 at the fourth pivotal connection 312. The first bracket 340 extends downward at an angle from the cross member 194 extending between the rails 130 and 132 of the support frame 120. In certain embodiments, the first bracket 340 extends downward from the cross member 194 at about a 57 degree angle relative to horizontal. Further, the connecting link 190B is connected to a second bracket 342 at the third pivotal connection 310. The second bracket 342 extends substantially parallel to the longitudinal axis 322 of the second frame section 172 and is connected to the cross member 192 of the second frame section. As shown, the second bracket 342 comprises a support portion 344 that engages the cross member 194 extending between the rails 130 and 132 of the support frame 120 when the foot end mattress support 124 is in the substantially flat position.

As illustrated in FIGS. 3A-3C, the extendable/retractable shaft 196 of the foot end actuator 142 is pivotally connected to the actuator support bracket 178 extending downward at an angle from the cross member 180 of the first frame section 170. As illustrated in FIG. 3C, the angle A₆ between the longitudinal axis 326 of the actuator support bracket 178 and horizontal H is generally between about 10 degrees and about 30 degrees. In certain embodiments, the angle A₆ between the longitudinal axis 326 of the actuator support bracket 178 and horizontal H is about 19 degrees. Further, the angle A₇ between the longitudinal axis 328 of the actuator shaft 196 and the longitudinal axis 326 of the actuator support bracket 178 ranges from about 20 degrees when the foot end mattress support 124 is in the substantially flat position to about 53 degrees when the foot end mattress support is in the elevated position.

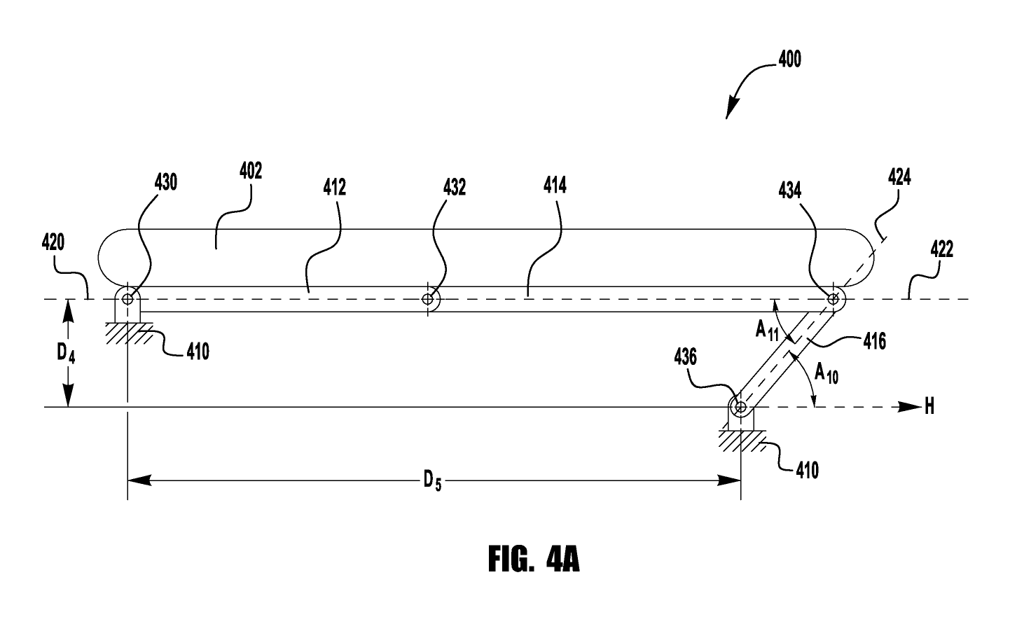

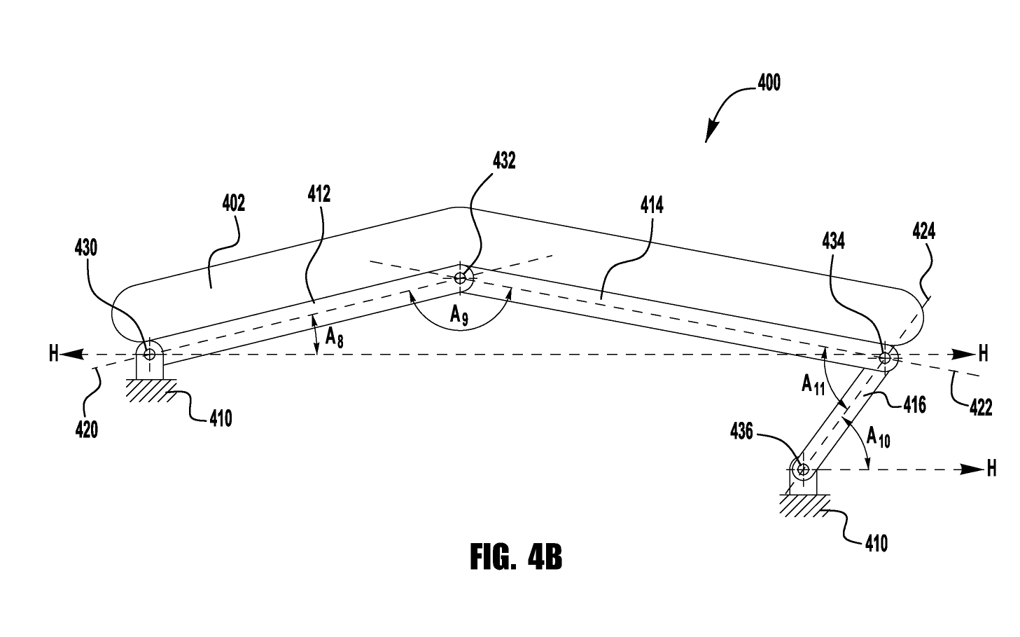

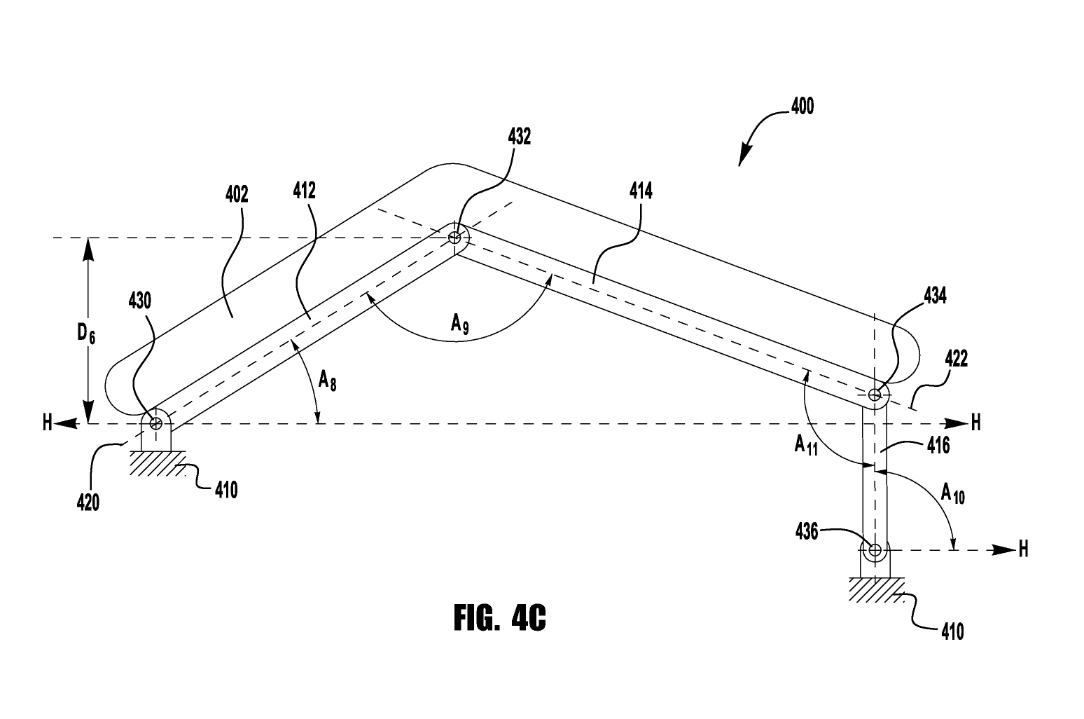

FIGS. 4A-4C illustrate a movable mattress support 400 for supporting a mattress 402 of a bed according to an embodiment of the present application. As shown, the mattress support 400 comprises a four bar linkage that moves the mattress support and the mattress 402 between a substantially flat or horizontal position shown in FIG. 4A, a partially elevated position shown in FIG. 4B, and an elevated position shown in FIG. 4C.

As illustrated in FIGS. 4A-4C, the mattress support 400 comprises first and second mattress support frames 412 and 414 that are pivotally coupled together. In certain embodiments, the first and second mattress support frames 412 and 414 are pivotally coupled together at or near the expected position of an occupant's knee area to follow the natural contours of a person. As such, in the elevated position, the occupant's knees are raised with the apex of the pivotally coupled frames 412 and 414. In certain embodiments, the vertical distance D₆ (see FIG. 4C) the pivotal connection 432 and the occupant's knees are raised from the substantially flat position to the elevated position is between about 175 mm and about 225 mm.

As illustrated in FIGS. 4A-4C, the first link of the four bar linkage is fixed and comprises a bed frame 410 of the bed. In certain embodiments, the bed frame 410 may comprise a pair of spaced apart rails and at least one cross member extending between the pair of spaced apart rails such as, for example, the support frame 120 of the bed platform 112.

As illustrated in FIGS. 4A-4C, the second link of the four bar linkage comprises the first mattress support frame 412 pivotally connected to the bed frame 410. In certain embodiments, the longitudinal axis 420 of the first mattress support frame 412 rotates from about 0 degrees to about 33 degrees relative to horizontal H (angle A₈) as the mattress support 400 moves between the substantially flat position and the elevated position.

As illustrated in FIGS. 4A-4C, the third link of the four bar linkage comprises the second mattress support frame 414 pivotally connected to the first mattress support frame 412. In certain embodiments, the angle A₉ between the longitudinal axis 420 of the first mattress support frame 412 and the longitudinal axis 422 of the second mattress support frame 414 decreases from about 180 degrees to about 127 degrees as the mattress support 400 moves between the substantially flat position and the elevated position.

As illustrated in FIGS. 4A-4C, the fourth link of the four bar linkage comprises a connecting link 416 pivotally connected to the second mattress support frame 414 and to the bed frame 410. In certain embodiments, the connecting link 416 is pivotally coupled to a cross member extending between rails of the bed frame 410 and is spaced away or inward from an outside edge of the rails. For example, in certain embodiments, the connecting link 416 is located at least 200 mm from the outside edge of each bed frame rail and below the mattress 402 of the bed. Further, in certain embodiments, the mattress support 400 may comprise more than one connecting link 416 pivotally connecting the second mattress support frame 414 and the bed frame 410, such as, for example, two, three, four, etc. connecting links.

In certain embodiments, the longitudinal axis 424 of the connecting link 416 rotates from about 48 degrees to about 90 degrees relative to horizontal H (angle A₁₀) as the mattress support 400 moves between the substantially flat position and the elevated position. Further, the angle A₁₁ between the longitudinal axis 422 of the second mattress support frame 414 and the longitudinal axis 424 of the connecting link 416 increases from about 48 degrees to about 111 degrees as the mattress support 400 moves between the substantially flat position and the elevated position.

Although not shown in FIGS. 4A-4C, an actuator is generally coupled to the bed frame 410 and to the mattress support 400 for moving the mattress support between the substantially flat position and the elevated position. The movable portion of the actuator, such as an extendable/retractable shaft of the actuator, may be coupled to any one or more of the second, third and fourth links to move the mattress support 400 between the substantially flat position and the elevated position. The actuator can take a wide variety of different forms. Examples of actuators include, but are not limited to electric actuators, hydraulic actuators, pneumatic actuators, pulley and cable arrangements, gear arrangements, nut and shaft arrangements, combinations and sub-combinations of any of these arrangements, and the like.

As illustrated in FIGS. 4A-4C, the first mattress support frame 412 is connected to the bed frame 410 at a first pivotal connection 430 and the second mattress support frame 414 at a second pivotal connection 432. The second mattress support frame 414 is connected to the connecting link 416 at a third pivotal connection 434 and the connecting link 416 is connected to the bed frame 410 at a fourth pivotal connection 436. In certain embodiments, the length of the first mattress support frame 412 between the first and second pivotal connections 430 and 432 is between about 250 mm and about 375 mm; the length of the second mattress support frame 414 between the second and third pivotal connections 432 and 434 is between about 450 mm and about 650 mm; and the length of the connecting link 416 between the third and fourth pivotal connections 434 and 436 is between about 100 mm and about 200 mm. In certain embodiments, the vertical distance D₄ between the first and fourth pivotal connections 430 and 436 is between about 75 mm and about 150 mm and the horizontal distance D₅ between the first and fourth pivotal connections is between about 700 mm and about 800 mm.

An adjustable bed, as described herein, may include an adjustment control system operable to independently adjust head and foot end mattress supports, for example, for separate tilting adjustment of the head and foot end sections of the mattress. As one example, an adjustable bed including separate head end and foot end actuators (e.g. hand crank actuators, electromechanical actuators, etc.) may include a controller having one or more controls (e.g., buttons, switches, hand cranks, etc.) for separately operating the head and foot end actuators for selective adjustment of the corresponding head and foot end sections of the mattress. Additionally or alternatively, an adjustable bed including separate head end and foot end actuators may include a controller having controls (e.g., buttons, switches, hand cranks, etc.) for simultaneously or synchronously operating the head and foot end actuators for simultaneous or synchronous adjustment of the corresponding head and foot end sections of the mattress. In one such example, an adjustable bed may be configured such that the head and foot end sections simultaneously or synchronously adjust in a predetermined relationship in response to user operation of a control component. For example, an angular adjustment of the head section of X degrees from a neutral (e.g., horizontal, flat, or low elevation/incline) position may be configured to correspond with an angular adjustment of the foot section of Y degrees from a neutral (e.g., horizontal, flat, or low elevation/incline) position. As one example, an adjustment control system may be configured to raise or incline the foot end section of the mattress when the head end section is raised, to prevent an occupant of the bed from sliding down the inclined head end section of the bed.

In an exemplary embodiment, an adjustment control system for synchronously operating adjustable head and foot end sections of a bed includes an electronic control circuit programmed to power electromechanical head and foot end actuators for a predetermined output (e.g., torque, duration, etc.) to position the head and foot end sections in desired angled positions in response to user operation of one or more controls. The adjustment control system may, for example, utilize one or more limit switches to terminate power to the electromechanical head and foot end actuators when the desired angled positions of the head and foot end sections have been reached. Additionally or alternatively, power to the electromechanical head and foot end actuators may be terminated by user operation of the one or more controls.

In another exemplary embodiment, a first end actuator (e.g., one of the head and foot end actuators) may comprise a powered actuator (e.g., control-driven electromechanical, pneumatic, or hydraulic or hand crank mechanical actuator) that adjusts a corresponding first end section (e.g., the corresponding one of the head and foot end sections), and a second end actuator (e.g., the other of the head end and foot end actuators) may comprise a linking actuator (e.g., cable and pulley arrangement, pivotally connected bar linkage, gear driven arrangement) mechanically connected with the first end section for automatic operation of the second end section in response to movement of the first end section. The linking arrangement may be configured to adjust the second end section in a predetermined relationship with the adjustment of the first end section by the first end actuator.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, hardware, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

While the present invention has been illustrated by the description of embodiments thereof, and while the embodiments have been described in considerable detail, it is not the intention of the applicant to restrict or in any way limit the scope of the invention to such detail. Additional advantages and modifications will readily appear to those skilled in the art. For example, the specific locations of the component connections and interplacements can be modified. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A bed, comprising:
a frame comprising a pair of spaced apart rails and at least one cross member extending between the pair of spaced apart rails;
a mattress support coupled to the frame and moveable between a substantially flat position and an elevated position, wherein the mattress support comprises a first section and a second section; and
an actuator coupled to the frame and to the mattress support for moving the mattress support between the substantially flat position and the elevated position;
wherein the first section is pivotally connected to the frame and to the second section, the second section is pivotally connected to at least one connecting link, and the connecting link is pivotally connected to the frame; and
wherein the connecting link is located at least 200 mm from an outside edge of each frame rail and the angle between the longitudinal axis of the connecting link and the longitudinal axis of the second section ranges from an acute angle when the mattress support is in the substantially flat position to an obtuse angle when the mattress support is in the elevated position.

2. (canceled)

3. The bed of claim 1 further comprising a first connecting link and a second connecting link, wherein each connecting link is pivotally connected to the second section and to the cross member extending between the rails of the frame.

4. The bed of claim 3, wherein each connecting link is located at least 200 mm from an outside edge of each frame rail.

5. The bed of claim 1, wherein the connecting link is configured to provide vertical separation between the bottom of the second section and the top of the frame rails.

6. The bed of claim 5, wherein the connecting link is configured to provide at least 25 mm of vertical separation between the bottom of the second section and the top of the frame rails when the mattress support is moving between the substantially flat position and the elevated position.

7. The bed of claim 1, wherein the first section is connected to the frame at a first pivotal connection, and wherein the connecting link maintains a continuous gap between the frame rails and the mattress support between the first pivotal connection and a distal end of the second section.

8. The bed of claim 7, wherein the bed comprises no moving parts proximate the frame rails and between the first pivotal connection and the distal end of the second section.

9. The bed of claim 1, wherein the first section, the second section, the connecting link, and the frame form a four bar linkage.

10. The bed of claim 1, wherein the first section is connected to the frame at a first pivotal connection and to the second section at a second pivotal connection; the second section is connected to the connecting link at a third pivotal connection; and the connecting link is connected to the frame at a fourth pivotal connection.

11. The bed of claim 10, wherein the fourth pivotal connection is located below the frame rails.

12. The bed of claim 10, wherein the connecting link is connected to a first bracket at the fourth pivotal connection, and wherein the first bracket extends downward at an angle from the cross member extending between the rails of the frame.

13. The bed of claim 12, wherein the connecting link is connected to a second bracket at the third pivotal connection, wherein the second bracket extends substantially parallel to a longitudinal axis of the second section and is connected to a cross member of the second section.

14. The bed of claim 13, wherein the second bracket comprises a support portion that engages the cross member extending between the rails of the frame when the mattress support is in the substantially flat position.

15. The bed of claim 1, wherein the first section is pivotally connected to each frame rail.

16. The bed of claim 1, wherein the actuator comprises an extendable/retractable shaft pivotally connected to an actuator support bracket extending downward at an angle from a cross member of the first section.

17. The bed of claim 16, wherein a longitudinal axis of the actuator support bracket extends downward from the cross member of the first section at an angle between about 10 degrees and about 30 degrees relative to horizontal.

18. The bed of claim 16, wherein the angle between the longitudinal axis of the actuator shaft and a longitudinal axis of the actuator support bracket increases from about 20 degrees to about 53 degrees as the mattress support moves between the substantially flat position and the elevated position.

19. A bed, comprising
a frame comprising a pair of spaced apart rails;
a mattress support coupled to the frame and moveable between a substantially flat position and an elevated position, wherein the mattress support comprises a first section pivotally connected to the frame at a first pivotal connection and a second section pivotally connected to the first section at a second pivotal connection, and wherein the angle between the longitudinal axis of the first section and the longitudinal axis of the second section ranges from about 180 degrees when the mattress support is in the substantially flat position to about 127 degrees when the mattress support is in the elevated position;
an actuator coupled to the frame and to the mattress support for moving the mattress support between the substantially flat position and the elevated position; and
a link connecting the second section to the frame and maintaining continuous gap between the frame rails and the mattress support between the first pivotal connection and a distal end of the second section as the mattress support moves from the substantially flat position to the elevated position, wherein the link is pivotally connected to the second section at a third pivotal connection and the frame at a fourth pivotal connection, and wherein the distance between the third and fourth pivotal connections is fixed as the mattress support moves from the substantially flat position to the elevated position.

20. A bed, comprising:
a frame comprising a pair of spaced apart rails;
a mattress support coupled to the frame and moveable between a substantially flat position and an elevated position, wherein the mattress support comprises a first section and a second section, and wherein the angle between the longitudinal axis of the first section and the longitudinal axis of the second section ranges from about 180 degrees when the mattress support is in the substantially flat position to about 127 degrees when the mattress support is in the elevated position; and
an actuator coupled to the frame and to the mattress support for moving the mattress support between the substantially flat position and the elevated position;
wherein the first section is pivotally connected to the frame at a first pivotal connection, the second section is pivotally connected to the first section at a second pivotal connection and at least one connecting link at a third pivotal connection, and the connecting link is pivotally connected to the frame at a fourth pivotal connection, and wherein the distance between the third and fourth pivotal connections is fixed as the mattress support moves from the substantially flat position to the elevated position; and
wherein the connecting link maintains a continuous gap between the frame rails and the mattress support between the first pivotal connection and a distal end of the second section as the mattress support moves from the substantially flat position to the elevated position, and wherein the connecting link is located at least 200 mm from an outside edge of each frame rail, and wherein the angle between the longitudinal axis of the connecting link and the longitudinal axis of the second section ranges from an acute angle when the mattress support is in the substantially flat position to an obtuse angle when the mattress support is in the elevated position.

21. The bed of claim 20, wherein the bed comprises no moving parts proximate the frame rails and between the first pivotal connection and the distal end of the second section.

22. The bed of claim 20, wherein the connecting link is pivotally connected to a cross member extending between the rails of the frame.

23. A method of adjusting a mattress support of a bed having a frame, a mattress support coupled to the frame and moveable between a substantially flat position and an elevated position, and an actuator coupled to the frame and to the mattress support for moving the mattress support relative to the frame, wherein the frame comprises a pair of spaced apart rails and the mattress support comprises a first section and a second section, and wherein the first section of the mattress support is pivotally connected to the frame at a first pivotal connection and to the second section at a second pivotal connection, and wherein the second section is pivotally connected to at least one connecting link and the connecting link is pivotally connected to the frame at a location at least 200 mm from an outside edge of each frame rail, the method comprising the steps of:
using the actuator to pivot the connecting link and move the mattress support between the substantially flat position and the elevated position, wherein the connecting link maintains a continuous gap between the frame rails and the mattress support between the first pivotal connection and a distal end of the second section as the mattress support moves between the substantially flat position and the elevated position, and wherein the angle between the longitudinal axis of the connecting link and the longitudinal axis of the second section ranges from an acute angle when the mattress support is in the substantially flat position to an obtuse angle when the mattress support is in the elevated position.

24. The method of claim 23, wherein the bed comprises no moving parts proximate the frame rails and between the first pivotal connection and the distal end of the second section.

25. The method of claim 23, wherein the connecting link is pivotally connected to a cross member extending between the rails of the frame.

26. The bed of claim 1, wherein the angle between the longitudinal axis of the connecting link and the longitudinal axis of the second section ranges from about 48 degrees when the mattress support is in the substantially flat position to about 111 degrees when the mattress support is in the elevated position.

27. The bed of claim 1, wherein the first section is connected to the frame at a first pivotal connection and to the second section at a second pivotal connection, the second section is connected to the connecting link at a third pivotal connection, and the connecting link is connected to the frame at a fourth pivotal connection, and wherein the distance between the third and fourth pivotal connections is fixed as the mattress support moves from the substantially flat position to the elevated position.
